(19) United States
(12) Patent Application Publication
(10) Pub. No.: US 2012/0202902 A1
(43) Pub. Date: Aug. 9, 2012

(54) FOAMING AGENT FOR PLASTICS

(75) Inventors: Rüdiger Wissemborski, Gau-Algesheim (DE); David Kümmet, Budenheim (DE); Hendrik Wermter, Eltville (DE); Rainer Schnee, Mainz (DE); Thomas Futterer, Ingelheim (DE)

(73) Assignee: Chemische Fabrik Budenheim KG, Budenheim (DE)

(21) Appl. No.: 13/382,536

(22) PCT Filed: Aug. 4, 2010
(86) PCT No.: PCT/EP10/61336

§ 371 Date: Feb. 6, 2012

(30) Foreign Application Priority Data
Aug. 14, 2009 (DE) 10 2009 028 562.8

(51) Int. Cl. C08J 9/12; C08G 69/00; C09K 3/00; C08F 110/02

(52) U.S. Cl. 521/85; 521/89; 521/143; 521/189; 516/13; 516/14

(57) ABSTRACT

A process for the production of foamed plastic parts, in which a blowing agent composition is introduced into a plastic matrix and causes pore formation in the plastic matrix by releasing at least carbon dioxide gas from the blowing agent composition, wherein the blowing agent composition contains at least one carbon dioxide carrier selected from carbonates, hydrogen carbonates and carbamates of alkali metals, alkaline earth metals, aluminum, transition metals and/or ammonium, and at least one acid carrier.

The invention concerns a process for the production of foamed plastic parts, in which a blowing agent composition is introduced into a plastic matrix and causes pore formation in the plastic matrix by releasing gas from the blowing agent composition. The invention also concerns the blowing agent itself and corresponding plastic parts produced by the process.

The production of foamed plastic parts is effected using blowing agents which are mixed with the plastic or dissolved therein and which provide for the production or liberation of gas in the plastic. In that case the production of gas can be effected by decomposition or reaction of the blowing agent or components in the blowing agent. The liberation of gas is frequently initiated and/or caused by heating and/or chemical reaction.

In the foaming operation the plastic part experiences a reduction in weight in relation to a unit of volume, that is to say a reduction in its density. The reduction in weight corresponds to the percentage proportion of the foamed plastic part which contains gas instead of plastic material, that is to say substantially the proportion by volume of pores in relation to the total volume of the plastic part.

The foaming of plastic parts can serve for different purposes, for example for reducing the weight of the part, the production of a thermally insulating part, the production of sponges, other absorbent foams or the production of floats. Depending on the respective purpose of use, account is to be taken of the fact that the mechanical, thermally insulating, chemical and other material properties can alter greatly due to the reduction in weight or the increase in the proportion of pores.

At the present time a distinction is drawn between different foaming processes:

1. Physical processes in which a gas is physically introduced into the molten plastic material and caused to expand. The gas bubbles produced in that case lead to foaming of the plastic. A disadvantage here is the high level of complication and cost in terms of apparatus and control technology. The plastic processing machines, for example extruders, have to be converted for foaming by means of a gas feed, at a high level of complication and expenditure. A further problem is matching the delivery and control of gas in connection with the melting characteristics of the plastic.

2. In the so-called solution method plastic proportions are dissolved out of a solid plastic material by means of suitable solvents. That gives rise to cavities and chambers which lead to a desired reduction in weight. The process however is already dubious for reasons of environmental protection and suffers from problems as the solvents used with the plastic components contained therein raise major disposal or recycling problems.

3. In chemical foaming processes HCFC-bearing products were primarily used in the past as blowing agent. For reasons of environmental compatibility however those blowing agents are increasingly avoided and replaced by others. Diazo compounds, N-nitroso compounds, sulfohydrazides, urea derivatives, guanidine derivatives, borohydride/water systems, carbonates and hydrogen carbonates are increasingly used. One disadvantage of the azo compounds is severe ammoniac formation upon decomposition and upon foaming, which raises doubts in regard to possible danger to health. Many carbonates and hydrogen carbonates break down uncontrolledly without further additives when reaching the degradation temperature. That results in uncontrolled foaming, possibly unwanted coloration and/or unwanted odor.

4. Foams can be very easily produced from polyurethane (PUR), which foams are known inter alia as foam rubber and are used as cleaning sponges, mattress materials or pillows, but also for heat insulation in buildings, refrigerators, heat and cold storage devices and for insulating pipe systems. Further areas of application for polyurethane foams have been opened up for some time, for example in vehicle construction. Polyurethane foams intended for heat insulation are made up of a closed-pore structure so that the cell gases with their low levels of thermal conductivity remain in the foamed cells. Earlier trichlorofluoromethane was frequently used as the cell gas. Because of the ozone-damaging nature of that halogenated hydrocarbon however it has been extensively replaced firstly by carbon dioxide and then by cyclopentane so that the foam cells nowadays generally contain a mixture of between about 10 and 30% of cyclopentane and carbon dioxide as the remainder.

Most blowing agents and foaming systems themselves or their reaction products are frequently dubious in respect of environment or health and/or give rise to problems upon processing or handling. Such a handling problem can be for example uncontrolledly fast, exothermic or excessively slow gas formation, which can have the result that either no correct foam formation at all takes place in the plastic parts or the foam structures do not comply with the desired requirements, for example because of non-uniform pore formation, unwanted pore sizes (excessively large or excessively small) and so forth.

Therefore the object of the present invention was to provide a process for the production of foamed plastic parts, in which the foaming conditions and gas formation can be better controlled than with known blowing agent systems, in which the blowing agents entail fewer or no disadvantages in regard to environment and/or health and which are distinguished by good handleability and good product properties.

That object is attained by a process of the kind set forth in the opening part of this specification for the production of foamed plastic parts, in which a blowing agent composition is introduced into a plastic matrix and causes pore formation in the plastic matrix by releasing at least carbon dioxide gas from the blowing agent composition, wherein the blowing agent composition contains the following constituents:

a) at least one carbon dioxide carrier selected from carbonates, hydrogen carbonates and carbamates of alkali metals, alkaline earth metals, aluminum, transition metals and/or ammonium, and

b) at least one acid carrier.

The blowing agent composition according to the invention which contains at least one carbon dioxide carrier and at least one acid carrier allows excellent control of gas formation. Adjustment of gas formation can be effected by a suitable choice of those components and the proportions thereof. The carbon dioxide carriers according to the invention are known in themselves at least in part as constituents of baking raising agents. The acid from the acid carrier provides for the reaction of the carbon dioxide carrier with the production or liberation of carbon dioxide gas for the foaming action. It was surprising that those basic substances, carbon dioxide carrier and acid carrier, are suitable for foaming plastic parts and in that situation have a large number of advantages over known foaming agents. For example most of the blowing agent compositions according to the invention are harmless to health, they are generally even suitable for foodstuffs, and they are environmentally acceptable. Thus the process according to the invention has considerable advantages over the known solution method, chemical foaming methods and also over the production of polyurethane foams.

A further advantage of the process according to the invention over many processes in the state of the art is good controllability of the foaming reaction as release of the carbon dioxide gas can be well controlled by suitable selection of the carbon dioxide carriers and the acid carriers and the compositions thereof.

In a preferred embodiment of the process according to the invention the blowing agent composition includes at least two different acid carriers, thereamong at least one first acid carrier (ST1) with a rate of reaction (ROR) of less than 28% CO₂, preferably less than 20% CO₂, and at least one second acid carrier (ST2) with a rate of reaction (ROR) of more than 28% CO₂, preferably more than 36% CO₂, wherein the ROR is defined as follows:

ROR=amount of CO₂ gas (mol) which actually occurs in percent in relation to the amount of CO₂ gas which can theoretically be obtained upon complete reaction upon reaction of a stoichiometric ratio of carbon dioxide carrier and acid carrier at a temperature of 21° C. for a period of 8 mins.

In a further preferred embodiment of the process according to the invention the blowing agent composition includes at least two different acid carriers, thereamong at least one first acid carrier (ST1) and at least one second acid carrier (ST2) whose rate of reaction (ROR) differs by at least 10% carbon dioxide, preferably by at least 20% carbon dioxide, wherein the ROR is as defined above.

The use according to the invention of at least two different acid carriers with different rates of reaction (ROR), namely a first acid carrier (ST1) with a lower rate of reaction than that of a second acid carrier (ST2) affords the surprising advantage of particularly uniform foaming and homogeneous pore formation. Without wishing to be bound down to a theory in that respect, it is assumed that a large number of small foam bubbles are formed by the combination of at least one slowly reacting and fast reacting acid carrier, firstly due to the acid carrier which reacts faster at relatively high speed, which bubbles are then filled in the reaction with the more slowly reacting acid carrier at relatively low speed. Very regular foaming and pore formation is observed in that case. That observation was surprising and could not be foreseen.

Particularly preferably the at least one carbon dioxide carrier is selected from sodium carbonate, sodium hydrogen carbonate, magnesium carbonate, magnesium hydrogen carbonate, calcium carbonate, calcium hydrogen carbonate, aluminum carbonate, aluminum hydrogen carbonate, iron carbonate, iron hydrogen carbonate, ammonium carbonate, ammonium hydrogen carbonate, ammonium carbamate and mixtures of the aforesaid.

The aforementioned compounds which are suitable according to the invention as carbon dioxide carriers are predominantly harmless in terms of health, in part even suitable for foodstuffs and environmentally acceptable. They are excellently well suitable for the controlled liberation of carbon dioxide by means of an acid carrier or a mixture of acid carriers.

Preferably the at least one acid carrier used in the invention is selected from salts of phosphorus-bearing oxoanions, preferably from phosphates, condensed phosphates, phosphonates, phosphites, mixed hydroxide phosphates and cyanurates.

Quite particularly preferably the at least one acid carrier is selected from acid sodium pyrophosphate (SAPP), monocalcium phosphate monohydrate (MCPM), dicalcium phosphate dihydrate (DCPD), sodium aluminum sulfate (SAS), sodium aluminum phosphate (SALP), calcium magnesium aluminum phosphate, calcium polyphosphate, magnesium polyphosphate and mixtures of the aforesaid.

The man skilled in the art can ascertain the amount of blowing agent composition which is to be introduced into a plastic matrix for the foaming operation, with a given plastic material, with knowledge of the invention, by means of few tests. The amount of blowing agent composition will depend inter alia on the plastic material used and to be foamed and on the blowing agent composition as well as the desired foaming result, having regard to the production or foaming conditions to be applied. In a preferred embodiment of the process according to the invention between 0.2 and 10% by weight of blowing agent composition is introduced into the plastic matrix, with respect to the weight of the plastic matrix. Further preferably between 0.5 and 6% by weight of blowing agent composition, particularly preferably between 1 and 3% by weight of blowing agent composition, is introduced into the plastic matrix.

The blowing agent composition is so selected or is such a composition that at ambient temperature as far as possible it does not yet break down or react away, with the formation of carbon dioxide gas. The release of carbon dioxide gas is preferably only to be effected at elevated temperature, in general at the processing temperature of the plastic material in the liquid or foamable state. Desirably with the process according to the invention release of at least carbon dioxide gas from the blowing agent composition is effected at a temperature in the range of between 80 and 400° C., preferably between 110 and 350° C., particularly preferably between 140 and 300° C.

Besides the selection of carbon dioxide carrier or carriers and acid carrier or carriers the properties and the reactivity of the blowing agent composition can also be influenced by additives. In preferred embodiments of the invention the blowing agent composition further contains a separating agent for preventing or delaying a premature reaction between carbon dioxide carrier and acid carrier, preferably selected from cereal starch such as corn starch, rice starch, wheat starch, modified flours, silicon dioxides such as pyrogenic silicic acid, hydrophobic silicic acid, hydrophilic silicic acid, tricalcium phosphates, calcium carbonate, calcium sulfate, silanes, fats and mixtures of the aforesaid. The addition of the separating agents can not only prevent or delay premature reaction between carbon dioxide carrier and acid carrier, but it can also influence the rate of reaction in the plastic matrix.

Introduction of the blowing agent composition is preferably effected by way of a so-called masterbatch. The term masterbatch is used to denote additives embedded in a plastic matrix in the form of granules in which the additives are present in content levels higher than in the end use. They are added to the plastic (raw polymer) to color it or to alter the properties thereof. Masterbatches have the advantage over the addition of various substances in the form of pastes, powders or liquids, that they ensure a high degree of process reliability and are very good to process. With a masterbatch, the attempt is generally made to concentrate the additive as much as possible, that is to say to use as little plastic matrix material as possible to embed the additive or additives. To produce a masterbatch the additives, for example also color pigments, are mixed with raw polymer, that is to say untreated plastic granulate. That mixture is then melted in an extruder and then granulated. Alternatively the components can also be directly mixed by way of different metering weighing devices in the extruder and melted. A masterbatch permits simply handling by virtue of good meterability.

In the case of producing the foaming agents according to the invention in a masterbatch, care is to be taken to ensure that the melting temperature of the polymer carrier material for the masterbatch is not higher than the foaming agent decomposition temperature. Therefore preferably low-melting polymers such as for example polyethylene, in particular LDPE or LLDPE and EVA are used here for the masterbatch.

The process according to the invention is suitable for the production of foamed plastic parts comprising substantially all kinds of plastic which can also be foamed with conventional foaming agents. The process according to the invention is particularly preferably used according to the invention for the production of foamed thermoplastics. Examples of suitable thermoplastic polymers are as follows:

Polyolefins such as polyethylene, polypropylene, polybutylene, polymethylpentene and block, graft and copolymers thereof, styrene polymers such as standard polystyrene, impact-resistant polystyrene, styrene acrylonitrile, acrylonitrile butadiene styrene, acrylonitrile styrene, acrylic rubber, halogen-bearing vinyl polymer such as polyvinyl chloride, polyvinylidene chloride, polyvinyl fluoride, tetrafluoromethylene hexafluoromethylene copolymer, ethylene tetrafluoroethylene copolymer, polychlorotrifluoroethylene, ethylene chlorotrifluoroethylene copolymer, acrylic polymers, polyacrylate, polymethacrylate, polyacetate such as polyoxymethylene, linear polycondensates such as polyamides (PA-6, PA-66, PA-610, PA-612, PA-11, PA-12 and so forth), polycarbonates, polyesters (for example polyethylene terephthalate, polybutylene terephthalate and so forth), polyimides, polyarylketones, polysulfones, polyurethanes, polyphenylenes, polymers of unsaturated alcohols and amines or acyl derivatives or acetals thereof such as polyvinyl alcohol, polyvinyl acetate, polyvinyl butyral, polyvinyl benzoate, cross-linked polycondensates and polyaducts such as phenoplasts, aminoplasts, epoxy resins, unsaturated polyesters, polyurethane, modified natural substances such as cellulose ester, including copolymers or mixtures of the aforementioned polymers.

The invention will now be described in greater detail by means of embodiments by way of example.

### EXAMPLE 1

200 g of low density polyethylene (LD-PE) were melted in a Brabender kneader, 2% by weight (4 g) of blowing agent composition was added and kneading was effected for a further 30 seconds. The kneader was stopped and the plastic removed. At the same time foaming occurred with an increase in the volume or a reduction in the material density.

The blowing agent compositions contained as the carbon dioxide carrier sodium hydrogen carbonate (NaHCO₃) in a quantitative relationship with the corresponding acid component, which corresponded to the neutralisation value. The acid component used in the various tests and the densities of the plastic parts produced, which were ascertained after foaming and as a control without foaming are set forth in Table 1 hereinafter.

The following acid carriers were used:

SAPP 10=acid sodium pyrophosphate with an ROR of 10% CO₂

SAPP 28=acid sodium pyrophosphate with an ROR of 28% CO₂

SAPP 40=acid sodium pyrophosphate with an ROR of 40% CO₂

SAS=sodium aluminum sulfate

MCPM=monocalcium phosphate monohydrate

DCPD=dicalcium phosphate dihydrate

TABLE 1

| Sample | Plastic | Acid component | Density (g/cm³) |
|---|---|---|---|
| 1 | LD-PE | — (control) | 0.78 |
| 2 | LD-PE | SAPP 10 | 0.66 |
| 3 | LD-PE | SAPP 28 | 0.52 |
| 4 | LD-PE | SAPP 40 | 0.77 |
| 5 | LD-PE | SAS | 0.56 |
| 6 | LD-PE | MCPM | 0.77 |
| 7 | LD-PE | DCPD | 0.50 |

### EXAMPLE 2

200 g of polyamide 66 (PA66; Badamid, BADA Plast, Bühl, Germany) was melted in a Brabender kneader, 2% by weight (4 g) of blowing agent composition was added and kneading was effected for a further 30 seconds. The kneader was stopped and the plastic removed. At the same time foaming occurred with an increase in the volume or a reduction in the material density.

The blowing agent compositions contained as the carbon dioxide carrier sodium hydrogen carbonate (NaHCO₃) in a quantitative relationship with the corresponding acid component, which corresponded to the neutralisation value. The acid component used in the various tests and the densities of the plastic parts produced, which were ascertained after foaming and as a control without foaming are set forth in Table 2 hereinafter.

TABLE 2

| Sample | Plastic | Acid component | Density (g/cm³) |
|---|---|---|---|
| 1 | PA66 | — (control) | 1.23 |
| 2 | PA66 | SAPP 10 | 1.04 |
| 3 | PA66 | SAPP 28 | 1.00 |
| 4 | PA66 | SAPP 40 | 0.93 |
| 5 | PA66 | SAS | 0.92 |
| 6 | PA66 | MCPM | 1.27 |

### EXAMPLE 3

Example 1 with low density polyethylene (LD-PE) was repeated, wherein the blowing agent composition contained 20% by weight of SAPP 40 and 80% by weight of SALP (=sodium aluminum phosphate; Na₃Al₂H₁₄(PO₄)₈). The weight saving or density achieved with that blowing agent composition which contained two blowing acids with differing ROR corresponded to that achieved with pure SALP, but the bubble structure of the plastic foamed with the blowing acid combination was considerably more uniform.

The reason for the more uniform bubble structure is assumed to be that the fast-reacting acid carrier firstly produces bubble seeds which are then ‘blown up’ by the more slowly reacting acid carrier. If just a fast-reacting acid carrier is used that gives very large bubbles which also connect to each other.

1. A process for the production of foamed plastic parts, in which a blowing agent composition is introduced into a plastic matrix and causes pore formation in the plastic matrix by releasing at least carbon dioxide gas from the blowing agent composition, wherein the blowing agent composition contains the following constituents:
a) at least one carbon dioxide carrier selected from carbonates, hydrogen carbonates and carbamates of alkali metals, alkaline earth metals, aluminum, transition metals and/or ammonium, and
b) at least one acid carrier.

2. A process as set forth in claim 1, wherein the blowing agent composition includes at least two different acid carriers, thereamong at least one first acid carrier (ST1) with a rate of reaction (ROR) of less than 28% CO₂, preferably less than 20% CO₂, and at least one second acid carrier (ST2) with a rate of reaction (ROR) of more than 28% CO₂, preferably more than 36% CO₂, wherein the ROR is defined as follows:
ROR=amount of CO₂ gas (mol) which actually occurs in percent in relation to the amount of CO₂ gas which can theoretically be obtained upon complete reaction upon reaction of a stoichiometric ratio of carbon dioxide carrier and acid carrier at a temperature of 21° C. for a period of 8 mins.

3. A process as set forth in claim 1, wherein the blowing agent composition includes at least two different acid carriers, thereamong at least one first acid carrier (ST1) and at least one second acid carrier (ST2) whose rate of reaction (ROR) differs by at least 10% CO₂, preferably by at least 20% CO₂, wherein the ROR is as defined above.

4. A process as set forth in claim 1, wherein the at least one carbon dioxide carrier is selected from the group consisting of sodium carbonate, sodium hydrogen carbonate, magnesium carbonate, magnesium hydrogen carbonate, calcium carbonate, calcium hydrogen carbonate, aluminum carbonate, aluminum hydrogen carbonate, iron carbonate, iron hydrogen carbonate, ammonium carbonate, ammonium hydrogen carbonate, ammonium carbamate and mixtures of the aforesaid.

5. A process as set forth in claim 1, wherein the at least one acid carrier is selected from the group of salts consisting of phosphorus-bearing oxoanions, preferably from phosphates, condensed phosphates, phosphonates, phosphites, mixed hydroxide phosphates and cyanurates.

6. A process as set forth in claim 1, wherein the at least one acid carrier is selected from the group consisting of acid sodium pyrophosphate (SAPP), monocalcium phosphate monohydrate (MCPM), dicalcium phosphate dihydrate (DCPD), sodium aluminum sulfate (SAS), sodium aluminum phosphate (SALP), calcium magnesium aluminum phosphate, calcium polyphosphate, magnesium polyphosphate and mixtures of the aforesaid.

7. A process as set forth in claim 1, wherein between 0.2 and 10% by weight of blowing agent composition, preferably between 0.5 and 6% by weight of blowing agent composition, particularly preferably between 1 and 3% by weight of blowing agent composition, is introduced into the plastic matrix, with respect to the weight of the plastic matrix.

8. A process as set forth in claim 1, wherein release of at least carbon dioxide gas from the blowing agent composition is effected at a temperature in the range of between 80 and 400° C., preferably between 110 and 350° C., particularly preferably between 140 and 300° C.

9. A process as set forth in claim 1, wherein the blowing agent composition further contains a separating agent for preventing or delaying a premature reaction between carbon dioxide carrier and acid carrier, selected from cereal starch such as corn starch, rice starch, wheat starch, modified flours, silicon dioxides such as pyrogenic silicic acid, hydrophobic silicic acid, hydrophilic silicic acid, tricalcium phosphates, calcium carbonate, calcium sulfate, silanes, fats and mixtures of the aforesaid.

10. A process as set forth in claim 1, wherein the plastic is a thermoplastic.

11. Foamed plastic parts produced by a process as set forth in claim 1.

12. A blowing agent composition as defined in claim 1 and which contains a) at least one carbon dioxide carrier selected from the group consisting of carbonates, hydrogen carbonates and carbamates of alkali metals, alkaline earth metals, aluminum, transition metals and/or ammonium, and b) at least one acid carrier, in powder form or embedded in a plastic matrix in granule form (masterbatch).

13. Use of a blowing agent composition as set forth in claim 12 for the production of foamed plastic parts.
